(19) United States
(12) Patent Application Publication
(10) Pub. No.: US 2015/0102695 A1
(43) Pub. Date: Apr. 16, 2015

(54) ELECTRIC MACHINE

(71) Applicant: DELTA ELECTRONICS (SHANGHAI) CO., LTD., Shanghai (CN)

(72) Inventors: Shi-Xiang ZHANG, Shanghai (CN); Sheng-Chuan ZHANG, Shanghai (CN); Hong-Cheng SHEU, Shanghai (CN)

(21) Appl. No.: 14/330,766

(22) Filed: Jul. 14, 2014

(30) Foreign Application Priority Data
Oct. 15, 2013 (CN) 201310482770.X

(51) Int. Cl. H02K 1/27

(52) U.S. Cl. CPC H02K 1/2766
USPC 310/156.53

(57) ABSTRACT

An electric machine includes a stator core, a rotor core, a shaft and at least one pair of magnets. The stator core surrounds the stator core. The rotor core enfolds the shaft and includes at least one groove. The groove includes a pair of sub-grooves. The sub-grooves define an angle α therebetween. The angle α satisfies: α<180°. The magnets are respectively accommodated in the sub-grooves of the groove.

### RELATED APPLICATIONS

This application claims priority to China Application Serial Number 201310482770.X, filed Oct. 15, 2013, which is herein incorporated by reference.

### BACKGROUND

1. Technical Field

Embodiments of the present disclosure relate to an electric machine.

2. Description of Related Art

An electric machine typically refers to an apparatus for converting energy between the mechanical energy and the electrical energy by electromagnetic induction. For example, an electric generator is an electric machine that converts the mechanical energy to the electrical energy, and an electric motor is an electric machine that converts the electrical energy to the mechanical energy.

A typical synchronous reluctance machine includes a stator and a rotor which has plural slots. The shape of the slots can be determined to make the reluctances unequal on different positions along the circumferential direction, such that the inductances on different positions are various. The product of the inductance difference and current of the stator provides torque to the rotor and make it rotate.

However, in the current synchronous reluctance machine, high current is required for the stator, which lowers the efficiency and the power factor of the synchronous reluctance machine.

### SUMMARY

One aspect of the present disclosure provides an electric machine that has high efficiency and power factor.

In accordance with one embodiment of the present disclosure, an electric machine includes a stator magnetic core, a rotor magnetic core, a shaft and a pair of permanent magnets. The stator magnetic core surrounds the rotor magnetic core. The rotor magnetic core enfolds the shaft and has at least one groove. The groove has a pair of sub-grooves. The sub-grooves define an angle α therebetween. The angle α satisfies: α<180°. The sub-grooves are symmetrical. The permanent magnets are respectively accommodated in the sub-grooves of the groove.

In the foregoing embodiment, because the permanent magnets are accommodated in the groove of the rotor magnetic core, and therefore, the flux linkage of the permanent magnets can improve the torque. Therefore, when the electric machine in accordance with the foregoing embodiment is used to generate the torque as the typical electric machine generates, the current required for the stator is lower. As a result, the foregoing embodiment can lower the current required for the stator, thereby improving the efficiency and the power factor of the electric machine.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of an electric machine in accordance with one embodiment of the present disclosure;

FIG. 2 is a fragmentary view of the rotor magnetic core;

FIG. 3 is a top view of the electric machine in accordance with another embodiment of the present disclosure; and

FIG. 4 is a fragmentary top view of the electric machine in accordance with another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

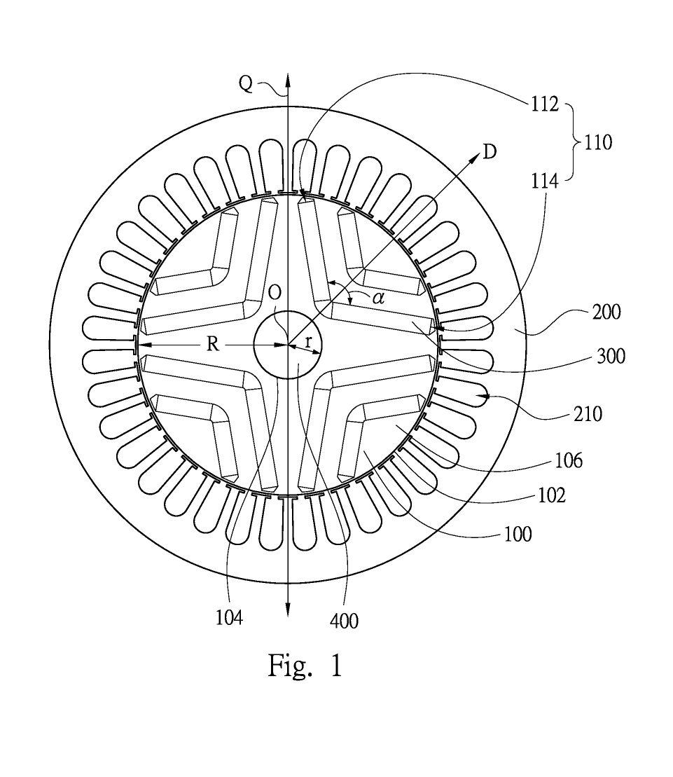

FIG. 1 is a top view of an electric machine in accordance with one embodiment of the present disclosure. As shown in FIG. 1, the electric machine includes a rotor magnetic core 100 and a stator magnetic core 200. The stator magnetic core 200 surrounds the rotor magnetic core 100. The rotor magnetic core 100 has at least one groove 110. The groove 110 is hollow and is not magnetically permeable. The D axis of the rotor magnetic core 100 is an axis that extends from the center O of the rotor magnetic core 100 toward the stator magnetic core 200, and the Q axis is another axis that extends from the center O toward the stator magnetic core 200. The D axis of the rotor magnetic core 100 passes through the groove 110, and the Q axis does not pass through the groove 110. Therefore, the reluctance of the rotor magnetic axis 100 on D axis is higher than the reluctance of the rotor magnetic axis 100 on Q axis. As a result, when the current in the stator magnetic core 200 varies and generates the magnetic field, the generated inductance on D axis of the rotor axis 100 is lower than the generated inductance on Q axis, and the inductance difference generates a torque that makes the rotor magnetic core 100 rotate. In particular, the torque Tₑₘ exerting on the rotor magnetic core 100 satisfies:

Tₑₘ=pψ_{f}i_{q}+p(L_{q}−L_{d})i_{q}i_{d} (Equation 1)

In the Equation 1, L_{q} is the inductance on Q axis of the rotor magnetic core 100;

L_{d} is the inductance on D axis of the rotor magnetic core 100;

i_{q} is the stator current on D axis of the stator magnetic core 200;

i_{d} is the stator current on Q axis of the stator magnetic core 200;

ψ_{f} is the permanent magnetic flux linkage; and

p is the number of pole pairs.

Based on the Equation 1, if the permanent magnetic flux linkage ψ_{f} is not high enough, the value of p(L_{q}−L_{d})i_{q}i_{d} is required to be higher. In other words, the stator current i_{q} and i_{d} is required to be high enough, so as to exert a certain extent of torque Tₑₘ to the rotor magnetic core 100.

In this embodiment, the electric machine includes at least one pair of permanent magnets 300. In other words, the electric machine can be a permanent magnet assisted synchronous reluctance machine. The permanent magnets 300 are accommodated in the groove 110, so as to improve the permanent magnetic flux linkage ψ_{f}. When the desired torque Tₑₘ is constant, the electric machine having the permanent magnets 300 provides higher permanent magnetic flux linkage ψ_{f}, and therefore, the value of p(L_{q}−L_{d})i_{q}i_{d} is lower, thereby reducing the value of the stator current i_{q} and i_{d}. As a result, the torque Tₑₘ exerting to the rotor magnetic core 100 can be high enough when the external power source supplies little stator current i_{q} and i_{d} to the stator magnetic core 200. Therefore, the electric machine with permanent magnets 300 requires power lower than the power that the electric machine without the permanent magnets 300 requires, and therefore, the efficiency of the electric machine with permanent magnets 300 can be improved. Further, because the values of the stator currents i_{q} and i_{d} are lowered, the reactive power of the electric machine can be lowered, which improves the power factor.

In view of the foregoing, the lower the values of the stator currents i_{q} and i_{d} are, the higher the efficiency and the power factor of the electric machine are. Therefore, lowering the values of the stator currents i_{q} and i_{d} is the key to improve the efficiency and the power factor of the electric machine.

One embodiment of the present disclosure is to increase the volume of the groove, so as to accommodate larger permanent magnets 300. In particular, the groove 110 can be a V-shaped groove. In other words, the groove 110 has a pair of sub-grooves 112 and 114. The sub-grooves 112 and 114 define an angle α therebetween. The angle α satisfies: α<180°. In other words, the sub-groove 112 and the sub-groove 114 are not parallel to each other. Based on the triangle inequality, separating the groove 110 as two sub-grooves 112 and 114 not parallel to each other increases the volume of the groove 110, so that the larger permanent magnets 300 can be accommodated, thereby improving the value of the permanent magnetic flux linkage ψ_{f} and lowering the values of the stator currents i_{q} and i_{d}. As a result, the efficiency and the power factor of the electric machine can be improved. The V-shaped groove can make the permanent magnets assembled in an easier manner, improve the manufacturing accuracy, simplify the mold and lower the cost.

The permanent magnets 300 have large volume, and therefore, the cost may be increased. Further, the permanent magnetic material is rare earth material, which is expensive. Therefore, in some embodiments, the material of the permanent magnets 300 comprises ferrite, which is cheaper than the rare earth material. Therefore, even if the permanent magnets 300 are larger, the cost still remains low. In other words, the efficiency and the power factor can be improved when the cost remains low.

Further, in some embodiments, the sub-grooves 112 and 114 are symmetrical. In other words, the sub-grooves 112 and 114 may be two grooves having the same shape and volume. Thus, the sub-grooves 112 and 114 respectively accommodate the permanent magnets 3000 having the same shape and volume. As a result, the manufacturer can put the same permanent magnets 300 respectively into the sub-grooves 112 and 114 rather than putting different permanent magnets 300 into the sub-grooves 112 and 114, so as to facilitate the manufacture of the electric machine. The term “the same” used herein does not mean two objects have to be exactly the same, and instead, the sub-groove or and the permanent magnet may have an allowed tolerance in consideration of the accuracy of the manufacture.

In some embodiments, the rotor magnetic core 100 can be an annular structure. In particular, the rotor magnetic core 100 includes an outer circumferential surface 102, an inner circumferential surface 104 and a top surface 106. The outer circumferential surface 102 is closer to the stator magnetic core 200 than the inner circumferential surface 104 is. The top surface 106 is adjoined to the outer circumferential surface 102 and the inner circumferential surface 104. The groove 110 is formed on the top surface 106. The rotor magnetic core 100 has an outer radius R and an inner radius r. The outer radius R means the distance between the outer circumferential surface 102 and the center O of the rotor magnetic core 100. The inner circumferential surface r means the distance between the inner circumferential surface 104 and the center O of the rotor magnetic core 100.

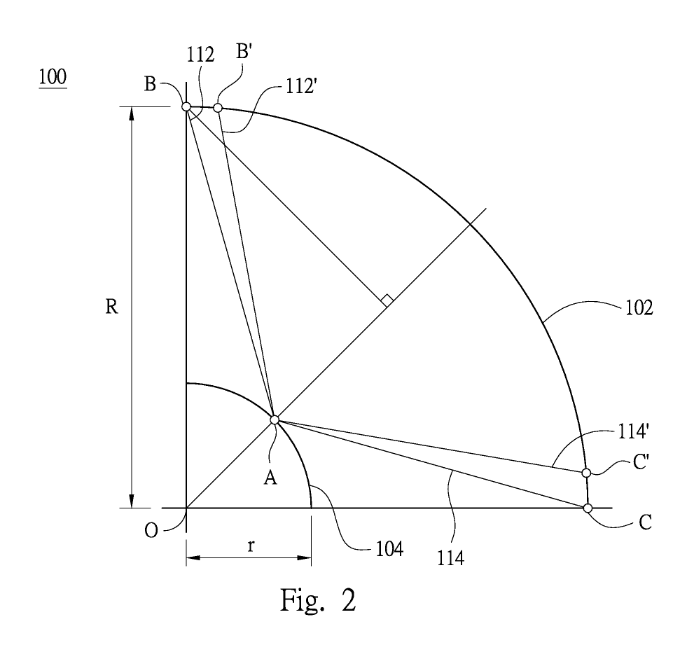

In some embodiments, when the angle α satisfies a certain condition, the groove 110 can be maximized. In particular, Reference can be now made to FIG. 2, which is a fragmentary view of the rotor magnetic core 100. As shown in FIG. 2, the point A is positioned on the inner circumferential surface 104 of the rotor magnetic core 100. The points B and C are positioned on the outer circumferential surface 102 of the rotor magnetic core 100. The line connecting the point B and the center O is perpendicular to the line connecting the point C and the center O. When the sub-grooves 112 and 114 are crossing on the inner circumferential surface 104 of the rotor magnetic core 100 (such as crossing on the point A of the inner circumference surface 104), and one end of the sub-groove 112 opposite to the point A is positioned on the point B, and one end of the sub-groove 114 opposite to the point A is positioned on the point C, the sub-grooves 112 and 114 can be maximized. In such a configuration, the angle α defined by the sub-grooves 112 and 114 (See FIG. 1) can be ∠BAC, and the angle α satisfies:

$$α ≅ 2 arctan \frac{\sqrt{2} R}{\sqrt{2} R - 2 r} . \qquad ( Equation 2 )$$

When the angle α (See FIG. 1) satisfies the Equation 2, namely, the angle α is substantially equal to

$$2 arctan \frac{\sqrt{2} R}{\sqrt{2} R - 2 r} ,$$

the sub-grooves 112 and 114 can be maximized, so as to accommodate the largest permanent magnets 300 (See FIG. 1), thereby improving the efficiency and the power factor of the electric machine.

However, when the angle α (See FIG. 1) satisfies the Equation 2, the sub-grooves 112 will be too close to the Q axis (See FIG. 1), which causes the reduction of the inductance L_{d}, such that the value of p(L_{q}−L_{d})i_{q}i_{d} in the Equation 1 is lowered, thereby reducing the torque Tₑₘ.

Therefore, in some embodiments, in order to improve the efficiency and the power factor of the electric machine without affecting the torque Tₑₘ, one end of the sub-groove 112′ opposite to the point A can be positioned on the point B′, and one end of the sub-groove 114′ opposite to the point A can be positioned on the point C′. The angle α defined between the sub-grooves 112′ and 114′ (See FIG. 1) can be ∠B′AC′, which satisfies:

$$α \leq 0.9 \times 2 arctan \frac{\sqrt{2} R}{\sqrt{2} R - 2 r} \qquad ( Equation 3 )$$

When the angle α (See FIG. 1) satisfies the Equation 3, the groove 110 (See FIG. 1) does not affect the inductance L_{q} of the Q axis of the rotor magnetic core 100, so as to improve the efficiency and the power factor of the electric machine without affecting the torque Tₑₘ.

Moreover, when the angle α is too small, the sub-groove 112′ will be too far from the Q axis (See FIG. 1), such that the inductance L_{q} of the Q axis of the rotor magnetic core 100 will be higher, which causes the inductance L_{q} of the Q axis of the rotor magnetic core 100 varies seriously and induces the torque ripple.

As a result, in some embodiments, in order to improve the efficiency and the power factor of the electric machine without affecting the torque Tₑₘ and without the torque ripple, the angle α defined between the sub-grooves 112′ and 114′ (See FIG. 1) satisfies:

$$0.8 \times 2 arctan \frac{\sqrt{2} R}{\sqrt{2} R - 2 r} \leq α \leq 0.9 \times 2 arctan \frac{\sqrt{2} R}{\sqrt{2} R - 2 r} . \qquad ( Equation 4 )$$

When the angle α (See FIG. 1) satisfies the Equation 4, the groove 110 (See FIG. 1) not only improves the efficiency and the power factor of the electric machine without affecting the torque Tₑₘ, but also prevents the torque ripple.

In some embodiments, the sub-grooves 112 and 114 are not crossing on the inner circumferential surface 104 of the rotor magnetic core 100, and instead, they are crossing on the position between the inner circumferential surface 104 and the outer circumferential surface 102 of the rotor magnetic core 100. As such, the angle α (See FIG. 1) between the sub-grooves 112 and 114 gets larger. Preferably, the angle α satisfies:

$$0.8 \times 2 arctan \frac{\sqrt{2} R}{\sqrt{2} R - 2 r} \leq α \leq 180 ° . \qquad ( Equation 5 )$$

When the angle α satisfies the Equation 5, it not only prevents the torque ripple, but also prevents the angle α to be 180°, so that the sub-grooves 112 and 114 do not connect as a straight groove, which reduces the volume of the sub-grooves 112 and 114.

In some embodiments, a number of pole pairs of the electric machine is P, and the angle α is related to the number of pole pairs P. In particular, considering the number of pole pairs P, the angle α satisfies:

$$\frac{2}{P} \times 0.8 \times 2 arctan \frac{\sqrt{2} R}{\sqrt{2} R - 2 r} \leq α \leq 180 ° . \qquad ( Equation 6 )$$

Alternatively, considering the number of pole pairs P, the angle α satisfies:

$$\frac{2}{P} \times 0.8 \times 2 arctan \frac{\sqrt{2} R}{\sqrt{2} R - 2 r} \leq α \leq \frac{2}{P} \times 0.9 \times 2 arctan \frac{\sqrt{2} R}{\sqrt{2} R - 2 r} . \qquad ( Equation 7 )$$

In some embodiments, preferably, the number of pole pairs P is two, namely, P=2.

In some embodiments, as shown in FIG. 1, the sub-grooves 112 and 114 are spatially connected. In other words, no interval is formed between the sub-grooves 112 and 114, so as to increase the volume of the groove 110.

In some embodiments, as shown in FIG. 1, the rotor magnetic core 110 is separated from the stator magnetic core 200. In other words, an interval is formed between the rotor magnetic core 100 and the stator magnetic core 200. As such, the stator magnetic core 200 does not affect the rotation of the rotor magnetic core 100.

In some embodiments, as shown in FIG. 1, the electric machine includes a shaft 400. The rotor magnetic core 100 enfolds the shaft 400. In particular, the inner circumference surface 104 of the rotor magnetic core 100 is in contact with the shaft 400.

In some embodiments, as shown in FIG. 1, the stator magnetic core 200 has a plurality of stator grooves 210. The stator grooves 210 surround the rotor magnetic core 100. A Coil (not shown) can be accommodated in the stator groove 210. When the coil is conducted, the rotor magnetic core 100 rotates due to the magnetic field.

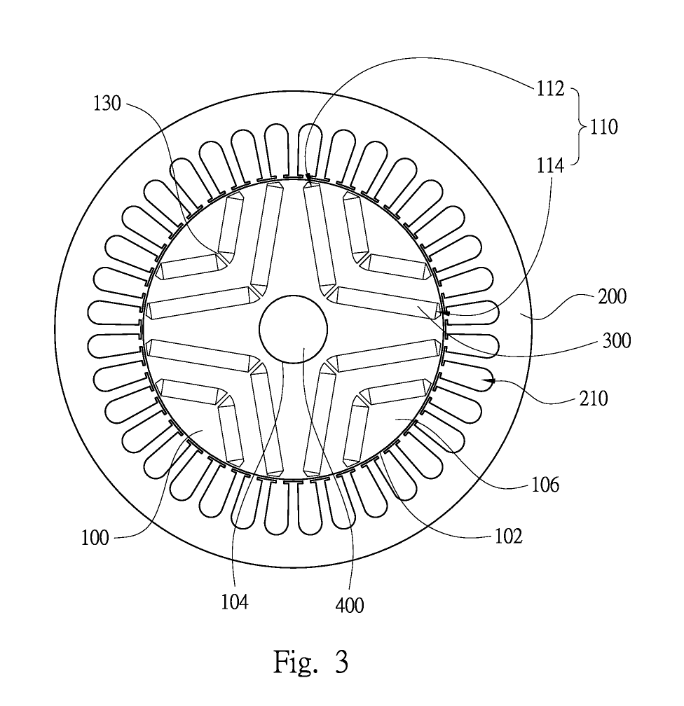

FIG. 3 is a top view of the electric machine in accordance with another embodiment of the present disclosure. As shown in FIG. 3, the main difference between this embodiment and previous embodiments is that: the rotor magnetic core 100 includes at least one separating rib 130. The separating rib 130 separates the sub-grooves 112 and 114 of the groove 110. In other words, in every groove 110, the sub-grooves 112 and 114 are spatially separated by the separating rib 130. By disposing the separating rib 130 between the sub-grooves 112 and 114, the structural strength of the rotor magnetic core 100 can be improved, so as to facilitate the rotor magnetic core 100 to rotate in high speed.

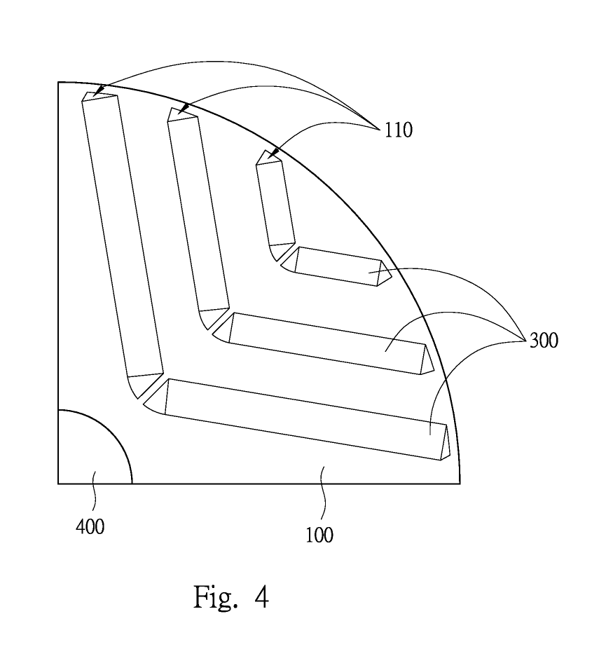

In some embodiments, as shown in FIG. 1, a plurality of grooves 110 and a plurality of pairs of the permanent magnets 300 can be arranged along the D axis of the rotor magnetic core 100. For example, as shown in FIG. 1, two grooves 110 and two pairs of the permanent magnets 300 are arranged along the D axis of the rotor magnetic core 100. FIG. 4 is a fragmentary top view of the electric machine in accordance with another embodiment of the present disclosure. In detail, as shown in FIG. 4, three grooves 110 and three pairs of the permanent magnets 300 can be arranged along the D axis of the rotor magnetic core 100, but this figure does not limit the number of the grooves 110 and the number of the permanent magnets 300 of the present disclosure. For example, in other embodiments, four, five or six grooves 110 and four, five or six permanent magnets 300 can be disposed on the D axis of the rotor magnetic axis 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electric machine, comprising:
a shaft;
a rotor magnetic core enfolding the shaft and having at least one groove, the groove having a pair of sub-grooves defining an angle α therebetween, wherein the angle α satisfies: α<180°, and the sub-grooves are symmetrical;
a stator magnetic core surrounding the rotor magnetic core; and
at least one pair of permanent magnets respectively accommodated in the sub-grooves of the groove.

2. The electric machine of claim 1, wherein the groove is V-shaped.

3. The electric machine of claim 1, wherein the rotor magnetic core has an outer radius R and an inner radius r, and a number of pole pairs of the electric machine is P, wherein the angle α satisfies:
$$\frac{2}{P} \times 0.8 \times 2 arctan \frac{\sqrt{2} R}{\sqrt{2} R - 2 r} \leq α \leq \frac{2}{P} \times 0.9 \times 2 arctan \frac{\sqrt{2} R}{\sqrt{2} R - 2 r} .$$

4. The electric machine of claim 3, wherein the number of pole pairs of the electric machine P is equal to 2.

5. The electric machine of claim 1, wherein the rotor magnetic core has an outer radius R and an inner radius r, and a number of pole pairs of the electric machine is P, wherein the angle α satisfies:
$$\frac{2}{P} \times 0.8 \times 2 arctan \frac{\sqrt{2} R}{\sqrt{2} R - 2 r} \leq α \leq 180 ° .$$

6. The electric machine of claim 5, wherein the number of pole pairs of the electric machine P is equal to 2.

7. The electric machine of claim 1, wherein material of the permanent magnets comprises ferrite.

8. The electric machine of claim 1, wherein the sub-grooves are spatially communicated.

9. The electric machine of claim 1, wherein the rotor magnetic core comprises at least one separating rib separating the sub-grooves.

10. The electric machine of claim 1, wherein a number of the groove is plural, and a number of the pair of the permanent magnets is plural, and the grooves and the pairs of the permanent magnets are arranged along an axis of the rotor magnetic core.

11. The electric machine of claim 1, wherein the rotor magnetic core has an inner circumferential surface in contact with the shaft, and the sub-grooves are crossing on the inner circumferential surface, and the rotor magnetic core has an outer radius R and an inner radius r, wherein the angle α satisfies:
$$α ≅ 2 arctan \frac{\sqrt{2} R}{\sqrt{2} R - 2 r} .$$

12. The electric machine of claim 1, wherein the electric machine is a permanent magnet assisted synchronous reluctance machine.
